(19) United States
(12) Patent Application Publication
(10) Pub. No.: US 2007/0297961 A1
(43) Pub. Date: Dec. 27, 2007

(54) System for removing sulfur oxides from recycled exhaust

(75) Inventors: Ronald Silver, Peoria, IL (US); Alexander G. Panov, Dunlap, IL (US); Paul W. Park, Peoria, IL (US); Julie M. Faas, Peoria, IL (US); Dennis L. Endicott, Hanna City, IL (US); Svetlana M. Zemskova, Edelstein, IL (US); Matthew Stefanick, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/475,076

(22) Filed: Jun. 27, 2006

(51) Int. Cl. B01D 53/50; B01D 53/94; C01B 23/00; F01N 3/00

(52) U.S. Cl. 423/212; 423/213.2; 60/274

(57) ABSTRACT

A system and method for treating exhaust gas are provided. The system has a source of combustion exhaust, a first fluid passageway and a second fluid passageway. The first fluid passageway directs combustion exhaust from the source into the atmosphere. The second fluid passageway directs combustion exhaust from the source back into the source. The system also has at least one sulfur-oxide-removing device. The sulfur-oxide-removing device is disposed within at least one of the first or second fluid passageways.

### U.S. GOVERNMENT RIGHTS

This invention was made with government support under the terms of Contract Number DE-AC06-76-RL01830 (CRADA number PNNL/211) awarded by the U.S. Department of Energy. The government may have certain rights in this invention.

### TECHNICAL FIELD

The present disclosure relates generally to a system and method for treating recycled exhaust, and more particularly, to a system and method for removing sulfur oxides from recycled exhaust.

### BACKGROUND

Combustion of fuels creates exhaust that may include a complex mixture of air pollutants. Due to increased attention given to the environment, exhaust-emission standards have become more stringent, and the amount and contents of effluent emitted to the atmosphere from an engine may be regulated according to the type of engine, size of engine, and/or class of engine. One method that has been implemented by engine manufacturers to comply with the regulation of these engine emissions is Exhaust-Gas Recirculation (EGR). EGR systems recirculate or recycle the engine exhaust into the intake air supply of the engine. However, the pollutants in the exhaust may include sulfur oxides (SOx) (i.e., SO₂ and SO₃), which may oxidize and hydrate to form sulfuric acid (H₂SO₄) that condenses on the surfaces of engine components leading to severe degradation and decreased life span. This problem is particularly significant in EGR systems because the rate of condensation increases as the exhaust gas cools when passing through the various EGR components. Eventually, this condensed, highly-corrosive H₂SO₄ is directed back into the engine itself with the potential to cause significant damage.

In order to minimize damage to engine components, it may be necessary to remove SOx from engine exhaust. One example of removing SOx from engine exhaust is described in US Patent Application Publication 2005/0169826 (826 patent application). In particular, the 826 patent application discloses an SOx scrubber. This apparatus contains high-capacity sulfur-oxide sorbents (adsorbents and/or absorbents) and is located upstream from a NOx/particulate filter. One particular sorbent, Cryptomelane (KₓMn₈O₁₆), was found to have a high SOx capacity making it especially useful for some applications. The SOx scrubber is used to remove SO₂ and SO₃ from exhaust to protect a Nitrogen-oxide (NOx)/particulate filter, which is fouled by the presence of SOx. In this case, the NOx/particulate filter has a higher affinity for the sulfur oxides than the nitrogen oxides it is designed to trap.

Although the 826 patent application discusses removing SOx from exhaust gas to prevent clogging of an NOx/particulate filter, it does not address removing the sulfuric-acid precursors from recycled exhaust to prevent acid corrosion of the engine or other downstream components.

### SUMMARY OF THE INVENTION

In one aspect, the present disclosure is directed to a system for treating exhaust. The system includes a source of combustion exhaust, a first fluid passageway directing combustion exhaust from the source into the atmosphere, and a second fluid passageway directing combustion exhaust from the source back into the source. The system also includes a sulfur-oxide-removing device disposed within at least one of the first and second fluid passageways.

In another aspect, the present disclosure is directed to a method of treating exhaust. The method includes combusting fuel to produce a first exhaust stream and a second exhaust stream, directing the first exhaust stream into the atmosphere, and combusting the second exhaust stream. The method also includes removing sulfur oxides from at least one of the first or second exhaust streams.

### BRIEF DESCRIPTION OF THE DRAWINGS

FIG. 1 is a diagrammatic illustration of an exemplary disclosed exhaust-gas recycling system.

FIG. 2 is a pictorial illustration of an exemplary disclosed honeycomb structure.

FIG. 3 is a pictorial illustration of an exemplary disclosed wire mesh structure.

FIG. 4 is a diagrammatic illustration of another exemplary disclosed exhaust-gas recycling system.

FIG. 5 is a diagrammatic illustration of another exemplary disclosed exhaust-gas recycling system.

FIG. 6 is a diagrammatic illustration of another exemplary disclosed exhaust-gas recycling system.

FIG. 7 is a diagrammatic illustration of another exemplary disclosed exhaust-gas recycling system.

### DETAILED DESCRIPTION

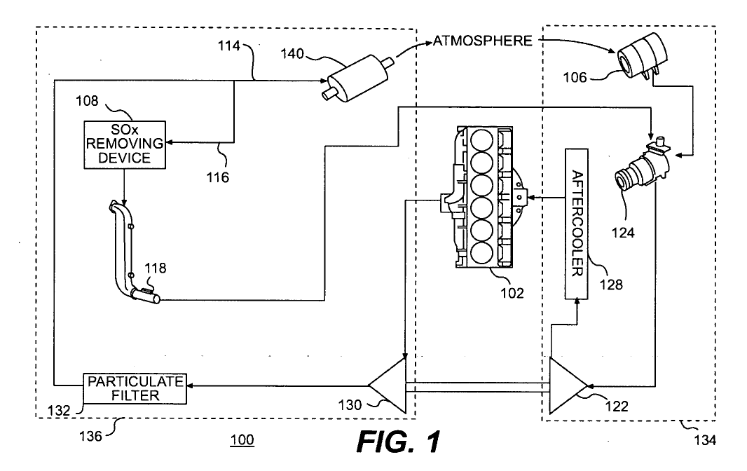

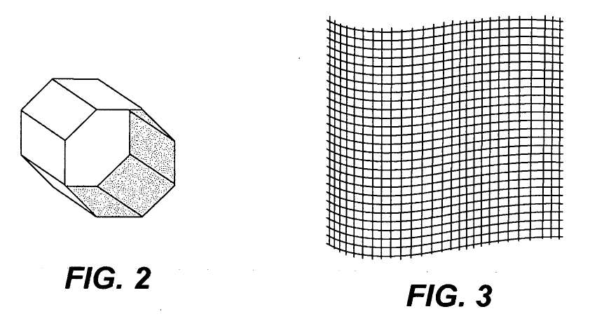

FIG. 1 illustrates an exemplary disclosed system 100 for treating exhaust. System 100 may include a combustion-exhaust source 102, an air-induction system 134, and an exhaust system 136. These components may be interconnected to facilitate the function of the system 100.

Combustion-exhaust source 102 may be configured to burn fuel producing exhaust as a byproduct. Combustion-exhaust source 102 may be an engine such as a diesel engine, a gasoline engine, a natural-gas engine or any other suitable type of engine that generates exhaust. Alternatively, combustion-exhaust source 102 may be any other source of combustion exhaust that is not associated with an engine, such as a furnace.

Air-induction system 134 may introduce air into combustion-exhaust source 102. Air-induction system 134 may include an air filter 106, a throttle/mixing valve 124, an air compressor 122, and an aftercooler 128. These components may be fluidly connected in a configuration that facilitates introduction of air into combustion-exhaust source 102.

Air filter 106 may remove or trap debris from air flowing into combustion-exhaust source 102. Air filter 106 may include any type of filter such as a full-flow filter, a self-cleaning filter, a centrifuge filter, an electro-static precipitator, or any other type of filter known in the art. More than one air filter 106 may be included within air-induction system 134.

Throttle/mixing valve 124 may be configured to mix atmospheric air and exhaust gas at a predetermined ratio. Throttle/mixing valve 124 may regulate the flow of the mixture into combustion-exhaust source 102. Separate exhaust and intake throttle valves may be implemented.

Compressor 122 may compress the air flowing into combustion-exhaust source 102 to a predetermined pressure and may be fluidly connected to aftercooler 128. Compressor 122 may be a fixed-geometry-type compressor, a variable-geometry-type compressor, or any other type of compressor. More than one compressor 122 may be included. Compressor 122 may be omitted, for example, when a non-compressed, air-induction system is desired.

Exhaust system 136 may direct exhaust out of combustion-exhaust source 102. Exhaust system 136 may include a turbine 130, a particulate filter 132, a first fluid passageway 114, a second fluid passageway 116, one or more SOx-removing devices 108, and an exhaust-gas cooler 118. Additional devices may be included within exhaust system 136 such as filters, catalysts, mufflers 140, and other emission-controlling devices. These components may be fluidly connected to direct the flow of combustion exhaust throughout system 100.

Turbine 130 may be connected to and receive exhaust from combustion-exhaust source 102 and compressor 122. As hot exhaust gases exiting combustion-exhaust source 102 expand, turbine 130 may be caused to rotate, thereby rotating connected compressor 122. More than one turbine 130 may be included within exhaust system 136. Turbine 130 may alternatively be omitted and compressor 122, if present, may be directly rotated by combustion-exhaust source 102 mechanically, hydraulically, electrically, or in any other manner.

Particulate filter 132 may collect solid and liquid pollutants from exhaust emitted by combustion-exhaust source 102. Particulate filter may include a wire mesh medium, a shallow- or deep-bed ceramic medium, or any other known medium through which the engine exhaust may be passed. Particulate filter 132 may be selectively and/or periodically regenerated to reduce buildup of collected particulate matter.

First fluid passageway 114 may direct exhaust gases from the combustion-exhaust source 102 into the atmosphere. Second fluid passageway 116 may direct exhaust gases from combustion-exhaust source 102 back into combustion-exhaust source 102. The two fluid passageways may be separate and distinct and may connect directly to combustion-exhaust source 102. Alternatively, the two fluid passageways may be connected as a common passageway with one fluid passageway branching off from the other at some point downstream from combustion-exhaust source 102.

The SOx-removing device 108 may include a container composed of metal, plastic, or any other material that can withstand the environment (e.g., temperatures and chemicals) present in the system in which it is placed. The container may have an input opening and an output opening to allow connection of the device to the first 114 or second passageway 116, and to allow the combustion exhaust to flow through it.

Within SOx-removing device 108 there may be any compound that removes sulfur oxides from a chemical solution that comes into contact with it. The compound must have a reasonable capacity for the adsorption or absorption of SOx. Examples of such a compound may include Magnesium (Mg), Calcium (Ca), Strontium (Sr), Manganese(Mn), Barium (Ba) and Lithium (Li) compounds, among others.

In one arrangement, Cryptomelane (KₓMn₈O₁₆) may be used as the adsorbent compound in SOx-removing device 108. The Potassium countercation, K+, provides charge compensation since Mn can assume an oxidation state of 4+, 3+ or 2+. Cryptomelane has a high relative surface area (˜80 m2/g) leading to strong adsorption kinetics and, therefore, high oxidation-reduction-reaction activity. Cryptomelane may be capable of removing SOx from exhaust gas within a temperature range of about 50° C. to 650° C. This may be in excess of the operating range of most engines used in motor-driven vehicles and most other combustion-exhaust sources. It may be advantageous to use Cryptomelane as the reactant within SOx-removing device 108 because it can be placed anywhere in the exhaust stream without degradation due to temperature. Further, there may be a significant change in the color of reacted Cryptomelane, which may be a reliable indicator of the need to replace or replenish SOx-removing device 108.

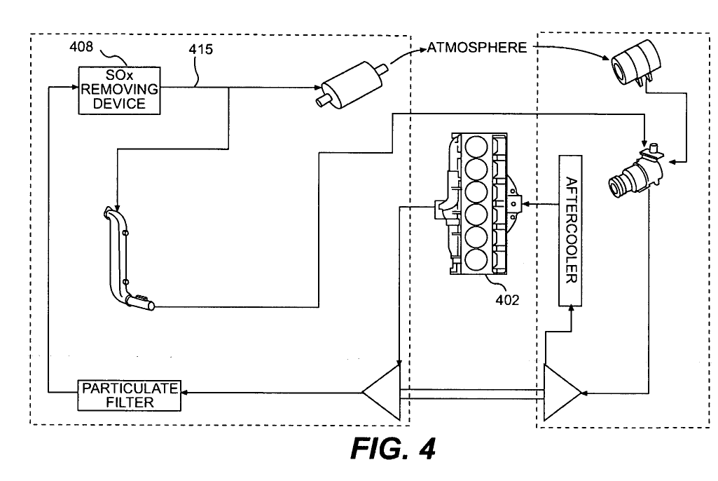

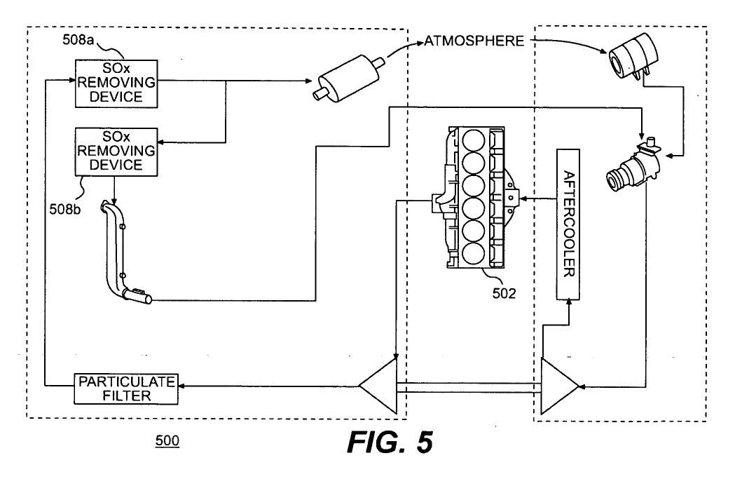

The compound within SOx-removing device 108 may be held or suspended in any form that allows maximal exposure of exhaust gas to facilitate reaction, while not impeding the flow of exhaust significantly. Examples of suitable support mechanisms may include pellets, powders, monolithic honeycomb structures (as illustrated in the example of FIG. 3), baffles, liquid suspensions, and screens fabricated from metal (as illustrated in the example of FIG. 4) or other compounds. The structure may be prepared by direct deposition of the compound or any other method known in the art.

SOx-removing device 108 may be constructed in such a way that the trapped SOx can be cleaned from the device 108. This may require that the compound be removed from SOx-removing device 108 and used to remake the compound from scratch. However, the compounds used in SOx-removing device 108 may have such a high affinity for sulfur oxides that regeneration of SOx-removing device 108 on-board a vehicle would be impractical.

SOx-removing device 108 may be constructed in such a way that it can be removed from the exemplary system to facilitate replacement. One example may be a device constructed similarly to an automobile oil filter that can be removed, discarded, and replaced as one complete unit fastened to the exhaust system 136 with a flange or a clamp. Another example may be a SOx-removing device 108 constructed with an opening mechanism (e.g., a trap door) such that the compound and its supporting structure can be removed and replaced without removing the device from the vehicle.

SOx-removing device 108 may be constructed to include an indicator of the remaining usable life of SOx-removing device 108. The indicator may be an opening or window that allows visual inspection of the compound within the device. Alternatively, SOx-removing device 108 may be replaced according to some fixed schedule based on vehicle mileage, in-service time, calendar time, or any other reasonable measure.

SOx-removing device 108 may be disposed at any position in exhaust system 136 in a quantity that maximizes the efficiency and the benefit of SOx removal. FIG. 1 shows an example of an exemplary disclosed system wherein SOx-removing device 108 is placed in a position such that only a portion of the exhaust from combustion-exhaust source 102 may be directed into SOx-removing device 108. This position may ensure that all recycled exhaust is treated before other engine components can be exposed to acidic-corrosion. The remaining untreated exhaust may be released into the atmosphere.

In another example illustrated in FIG. 4., all of the exhaust gas from combustion-exhaust source 402 may be directed into SOx-removing device 408 via a common first and second passageway 415 before any is released into the atmosphere or directed back to the combustion-exhaust source 402. This position may ensure that all exhaust (whether recycled or not) is treated before other engine components, including downstream exhaust treatment devices, can be exposed to acidic-corrosion. It may also ensure that SOx are not released into the atmosphere.

Alternatively, multiple SOx-removing devices may be used in an exemplary disclosed system as shown in the example of FIG. 5. These SOx-removing device devices may be placed in sequence (e.g., positions 508a and 508b) such that the exhaust stream from combustion-exhaust source 502 or a portion thereof is treated at multiple locations. Multiple treatment of the exhaust gas may improve the efficiency of the system 500 and increase the percentage of SOx removed.

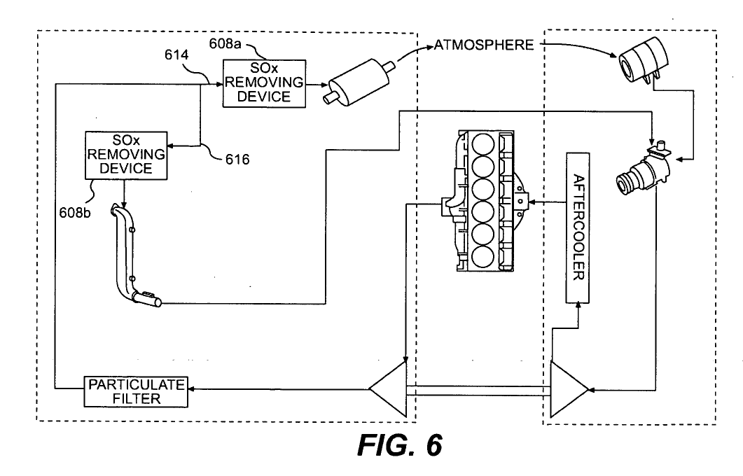

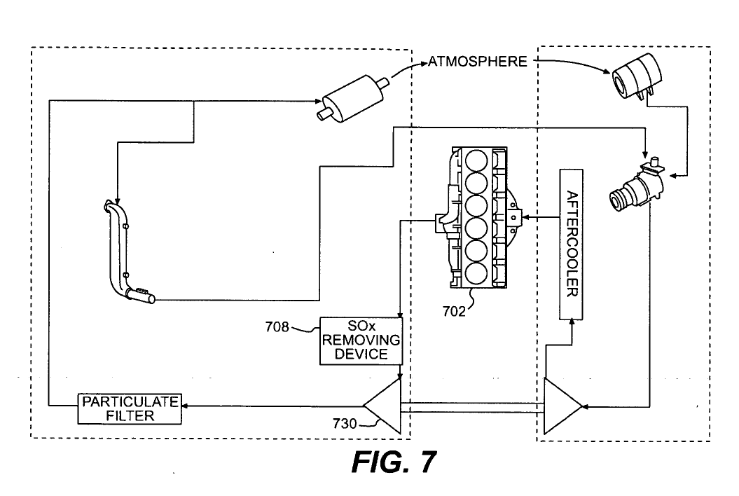

As in the example illustrated in FIG. 6, SOx-removing devices may be placed in both of the first 614 and second 616 fluid passageways (e.g., 608a and 608b) thus treating both recycled and released exhaust to the benefits of SOx removal. In yet another example, SOx-removing device 708 may be placed upstream of turbine 730, as illustrated in the exemplary system shown in FIG. 7. In this position, heat from combustion-exhaust source 702 and the elevated temperature of the exhaust-gas stream may facilitate the SOx-removal chemical reaction.

### INDUSTRIAL APPLICABILITY

The disclosed exhaust-treatment system may be applicable to any combustion system that incorporates an Exhaust Gas Recirculation (EGR) system. Examples may include the power source of a motor vehicle or the furnace of an electricity-generating facility and other combustion systems known in the art. The disclosed exhaust-treatment system may reduce the SOx in the exhaust gas and thereby minimize or eliminate condensation of H₂SO₄ and subsequent damage to all engine components that come in contact with the recycled exhaust.

The method for using the disclosed system can be illustrated by the example shown in FIG. 1. Combustion-exhaust source 102 may take in air and combust it with fuel producing mechanical-work output and exhaust gas. Combustion-exhaust source 102 may then expel the untreated exhaust. Some or all of the expelled exhaust may be treated before any is released into the atmosphere by placement of SOx-removing device 108 in an appropriate position. Within this SOx-removing device 108 the exhaust gas may be exposed to a compound that traps SOx, the precursors to H₂SO₄. The treated exhaust may then be expelled from SOx-removing device 108 and recycled back to combustion-exhaust source 102. The treated exhaust and atmospheric air may then be taken up by combustion-exhaust source 102 for continued operation.

In removing SOx from the exhaust gas using Cryptomelane, the following reaction may take place:

8SO₂+KₓMn₈O₁₆+(x/4)O₂→8MnSO₄+(x/2)K₂O

(where “x” is the amount of Mn³⁺ in KxMn₈O₁₆). Here the SO₂ is oxidized to SO₃ by Mn⁴⁺ and Mn³⁺. Mn⁴⁺ and Mn³⁺ are simultaneously reduced to Mn²⁺ as MnO. The SO₃ then reacts with Mn²⁺ to form MnSO₄.

Implementation of the disclosed system and method may reduce formation of sulfuric acid (H₂SO₄) by removing its sulfur-oxide precursors, SO₂ and SO₃, from the exhaust stream. This, in turn, may minimize acidic-corrosion degradation of all system components. Ultimately, this may improve the life span of the system and its components and possibly system performance.

It will be apparent to those skilled in the art that various modifications and variations can be made to the disclosed system and method. Other embodiments will be apparent to those skilled in the art from consideration of the specification and practice of the disclosed system and method. The examples used to illustrate the system show an engine used to power a motor vehicle. Alternatively, the combustion-exhaust source may be any source of combustion exhaust known in the art such as a furnace that is not associated with an engine. It is intended that the specification and examples be considered as exemplary only, with a true scope being indicated by the following claims and their equivalents.

What is claimed is:

1. A system for treating exhaust, comprising:
a source of combustion exhaust;
a first fluid passageway directing combustion exhaust from the source into the atmosphere;
a second fluid passageway directing combustion exhaust from the source back into the source; and
a sulfur-oxide-removing device disposed within at least one of the first and second fluid passageways.

2. The system of claim 1, wherein the sulfur-oxide-removing device is positioned within only the second fluid passageway.

3. The system of claim 2, further including an additional sulfur-oxide-removing device positioned within only the first fluid passageway.

4. The system of claim 1, further including at least one additional sulfur-oxide-removing device positioned upstream from the first and second fluid passageway.

5. The system of claim 1, wherein the sulfur-oxide-removing device contains Cryptomelane (KₓMn₈O₁₆).

6. The system of claim 5, wherein the sulfur-oxide-removing device includes a honeycomb structure coated with the Cryptomelane.

7. The system of claim 5, wherein the sulfur-oxide-removing device includes a metallic-screen structure coated with the Cryptomelane.

8. The system of claim 1, wherein all of the combustion exhaust from the source is directed through at least one sulfur-oxide-removing device.

9. A method of treating exhaust, comprising:
combusting fuel to produce a first exhaust stream and a second exhaust stream;
directing the first exhaust stream into the atmosphere;
combusting the second exhaust stream; and
removing sulfur oxides from at least one of the first or second exhaust streams.

10. The method of claim 9, wherein removing includes removing sulfur oxides from only the second exhaust stream.

11. The method of claim 9, wherein removing includes removing sulfur oxides from both the first and second exhaust streams.

12. The method of claim 9, further comprising removing sulfur oxides from at least one of the first or second exhaust streams at multiple locations.

13. A power system, comprising:
an internal combustion engine configured to combust a mixture of fuel and air and generate an exhaust flow;
an air-induction passageway directing air into the engine;
an exhaust passageway directing combustion exhaust from the engine into the atmosphere;
a recirculation passageway directing combustion exhaust from the engine into the air-induction passageway; and
a device containing a sulfur-oxide-removing compound, wherein the device is disposed within at least one of the exhaust passageway and the recirculation passageway.

14. The system of claim 13, further including an exhaust cooler disposed within the recirculation passageway, wherein the sulfur-oxide-removing device is positioned upstream from the exhaust cooler.

15. The system of claim 13, further including a particulate filter disposed upstream from the sulfur-oxide-removing device.

16. The system of claim 13, wherein the sulfur-oxide-removing compound comprises Cryptomelane (KₓMn₈O₁₆).

17. The system of claim 13, wherein the device includes at least one of a honeycomb structure coated with Cryptomelane and a metallic-screen structure coated with the Cryptomelane.

18. The system of claim 13, wherein the device is positioned within only the recirculation passageway.

19. The system of claim 18, further including an additional device containing a sulfur-oxide-removing compound, wherein the additional device is positioned within only the exhaust passageway.

20. The system of claim 18, further including an additional device containing a sulfur-oxide-removing compound wherein the additional device is positioned within only the recirculation passageway.
